(19) United States
(12) Patent Application Publication
(10) Pub. No.: US 2016/0030279 A1
(43) Pub. Date: Feb. 4, 2016

(54) CONFIGURABLE PERSONAL MASSAGING DEVICE

(71) Applicant: DIMENSIONAL INDUSTRIES, INC., San Diego, CA (US)

(72) Inventors: Jonathan Daniel Driscoll, San Diego, CA (US); Aaron Tynes Hammack, Berkeley, CA (US)

(21) Appl. No.: 14/885,190

(22) Filed: Oct. 16, 2015

Related U.S. Application Data
(63) Continuation-in-part of application No. 14/065,377, filed on Oct. 28, 2013.
(60) Provisional application No. 62/065,507, filed on Oct. 17, 2014.

(51) Int. Cl. A61H 19/00; A61H 1/00

(52) U.S. Cl. CPC A61H 19/00; A61H 1/00; A61H 2205/087; A61H 2201/5058; A61H 2201/5064; A61H 2201/5071; A61H 2201/5092

(57) ABSTRACT

Methods and systems are disclosed for configuring a sexual stimulation device, the method comprising: receiving a configuration template; receiving a plurality of sensor profiles from a plurality of sensors; wherein, one or more of the plurality of sensor profiles are associated with a biofeedback response by a person using the sexual stimulation device; wherein, one or more of the plurality of sensor profiles are associated with a position, orientation, or motion of the sexual stimulation device; interpreting the plurality of sensor profiles using the configuration template; and generating an output, using the configuration template, based on the interpreted plurality of sensor profiles.

### PRIORITY PATENT APPLICATIONS

The present application is non-provisional patent application drawing priority from co-pending U.S. provisional patent application Ser. No. 62/065,507; filed Oct. 17, 2014. The present application is also a continuation-in-part patent application drawing priority from co-pending U.S. patent application Ser. No. 14/065,377; filed Oct. 28, 2013. This present patent application draws priority from the referenced patent applications. The entire disclosure of the referenced patent applications is considered part of the disclosure of the present application and is hereby incorporated by reference herein in its entirety.

### TECHNICAL FIELD

The present disclosure relates to a configurable sexual stimulation device or “personal massaging apparatus” designed to output physical stimulus based on biofeedback data gathered by sensors and algorithms contained in downloadable configuration templates.

### BACKGROUND

The therapeutic effect of vibratory or other stimulation on the human body has been well documented. Typically, personal massagers, such as handheld massagers, vibrating adult toys, and massage chairs, are designed to be completely autonomous, or to incorporate data from integrated sensors, such as pressure sensors or accelerometers. Moreover, conventional personal massagers are capable of storing pre-programmed routines selected by a user and downloadable via a USB connection, for example.

The prior art fails to disclose a device that responds to biofeedback data gathered through sensors attached to or in close proximity with the person using the device. The prior art also fails to disclose means for configuring such devices using downloadable configuration templates.

### BRIEF DESCRIPTION OF THE DRAWINGS

The present embodiments are illustrated by way of example and are not intended to be limited by the figures of the accompanying drawings. In the drawings:

FIG. 1 shows a conceptual diagram of an example personal massaging device (PMD), according to some embodiments of the present disclosure;

FIG. 2 shows a conceptual block diagram of an example system architecture for a PMD, according to some embodiments;

FIG. 3 shows a conceptual diagram of an example system for configuring a PMD, according to some embodiments;

FIG. 4 shows a conceptual diagram of an example system for configuring a PMD, according to some embodiments;

FIG. 5 shows a flow chart of an example method for configuring a PMD, according to some embodiments; and

FIG. 6 shows a diagrammatic representation of a machine in the example form of a computer system within which a set of instructions, for causing the machine to perform any one or more of the methodologies discussed herein, may be performed.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. Thus, the present disclosure is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs. Moreover, it should be understood that the specific order or hierarchy of functional steps in the processes disclosed herein is an example of exemplary approaches. Based upon design preferences, it is understood that the specific order or hierarchy of steps in the processes may be rearranged while remaining within the scope of the present disclosure.

### Personal Massaging Device and Configuration Template

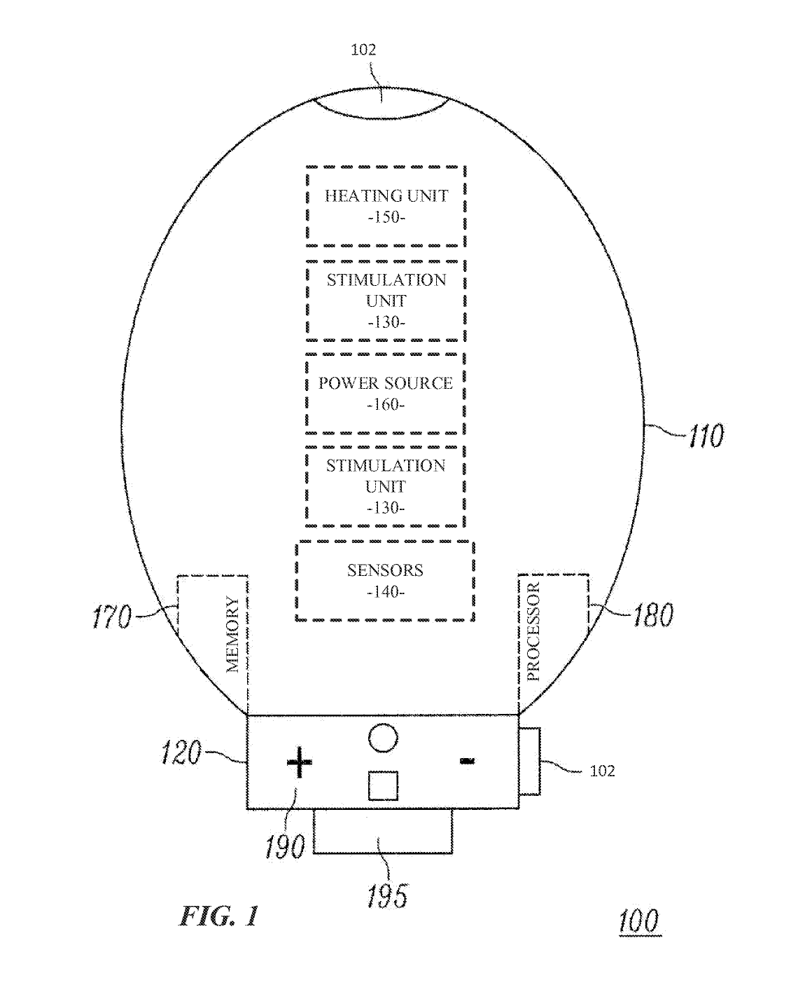

FIG. 1 shows a conceptual diagram of an example personal massaging device (herein referred to as a PMD) 100, according to some embodiments of the present disclosure. As shown in FIG. 1, the PMD 100 may include a main body 110 that may house electronics and power source(s) 160 to operate the device.

PMD 100 may include one or more stimulation unit(s) 130 which may be configured to create a stimulus output which may cause a physiological response by a user. According to some embodiments, the stimulation unit(s) 130 may be configured to cause a sexual response (e.g., arousal, orgasm, etc.) by the user. Stimulation unit(s) may include, but are not limited to: vibrator motors (that may cause the PMD to vibrate), heat sources (that may cause the PMD to heat up), electromyostimulation devices (that may cause muscle stimulation through the application of electrical current via electrodes in contact with the body of a user), and any other devices configured to provide an output that may cause a physiological response in human.

PMD 100 may include or be associated with one or more sensor(s) 102. Sensors 102 may include, but are not limited to: electric biopotential sensors, optical sensors, pressure/force sensors, thermal sensors, moisture sensors, acoustic sensors, chemical sensors and any other sensor types configured to sense one or more aspects of a user's response to a stimulus (e.g., as provided by stimulation unit 130). As an example, for illustrative purposes, the heart rate of a person may be sensed using different types of sensors. Biopotential sensors in contact with the skin of a user may sense the difference in electrical potential caused by the action of the heart. Conversely, an electro optical sensor may sense the difference in reflected light off the skin of a user from a light source (e.g., an infrared (IR) diode) caused by the changing blood volume as the heart beats. The measurements from such a sensor may be used to determine heart rate as well as blood oxygen levels. This is sometimes referred to as a pulse oximeter. According to some embodiments, light from the light source may be visible (e.g., red or green) or invisible (e.g., infrared (IR)). According to some embodiments, the PMD 100 may be completely encased by a seamless overmold, for example made of silicone. In such embodiments, a light source may be selected that has high transmission properties through the overmold so that the optical sensor may be installed within the overmold. For example, some silicone polymers exhibit good transmission of IR and near-IR wavelengths.

A person having ordinary skill in the art will recognize in view of the disclosure herein that number of different sensors may be implemented with a PMD 100 to sense the response of a user to applied stimuli. According to some embodiments, sensors 102 may include electrocardiogram (EKG or ECG) electrodes placed near a body of a person, specifically the heart of a person. Sensor units 102 could similarly be capacitive sensors or any other conventional sensors used to obtain EKG or ECG signals. The voltage signal generated by the heart can be easily measured, typically on the millivolt level, using appropriately positioned sensor units 102. Frequently, dual sensors can be used, which process the signal differentially, thus dramatically reducing noise and pickup from electromagnetic interference (EMI) or capacitively coupled sources, such as power lines.

According to some embodiments, sensor profiles gathered from some sensors may be used to process or ‘filter” sensor profiles gathered form other sensors. For example, as previously mentioned, an electro-optical sensor may use reflected light to detect changing blood volume and thereby detect a heartbeat and/or rate. However, detecting such based on changing blood volume presents a challenge where the optical transmitter/receiver of an optical sensor is in motion. To counter motion induced sensor data artifacts, data from other sensors may be applied to process or filter the sensor data artifacts. According to some embodiments, motion data gathered by an accelerometer, global positioning system (GPS), or proximity sensor, may be used to normalize the effects of the motion of the optical sensor. Further, according to some embodiments, pressure data gathered by pressure sensors may be applied to determine motion (e.g., through an inference based on pressure sensor patterns over a surface), and thereby normalize the effects of motion of the optical sensor.

In the exemplary embodiment depicted in FIG. 1, the sensor unit(s) 102 are incorporated as part of the body of PMD 100; however, a person having ordinary skill in the art will recognize in view of the disclosure herein that sensor(s) 102 may be implemented apart from the body of PMD 100 and communicatively connect to the other components of PMD 100 to transmit sensor data.

PMD 100 may also include one or more sensor(s) 140 configured to detect the position, orientation, and/or motion of the PMD 100. Sensor(s) 140 may include but are not limited to accelerometers (which may be any combination of accelerometer, gyroscope, and/or compass for sensing positioning and movement of the PMD 100), inertial measurement units (IMUs) (which may be any combination of accelerometers, gyroscopes, and manometers), proximity sensors, global positioning transceivers, and any other sensor device configured to detect the position, orientation, and/or motion of the PMD 100. Sensors 140 may also include, but are not limited to: electric biopotential sensors, optical sensors, pressure/force sensors, thermal sensors, moisture sensors, acoustic sensors, chemical sensors and any other sensor types configured to sense one or more aspects of a user's response to a stimulus (e.g., as provided by stimulation unit 130).

As will be described in more detail herein, according to some embodiments of the present disclosure, PMD 100 may through the use of stimulation unit(s) 130 cause a physiological response in a person using the device, specifically a sexual response. Data (in either a processed or raw form) received from the sensors 102 associated with PMD 100 may be analyzed or “interpreted” via the processing unit according to configuration data included in a configuration template.

The sensor data received from sensors 102 (and 140) may be referred to herein as a “sensor profile” or “sensor data.” As used herein, a “sensor profile” may refer to a set of raw and/or processed sensor data associated with one or more particular sensors. For example a “thermal sensor profile” may include one or more sets of raw and/or processed sensor data from discrete sensors configured to sense temperature or heat. Heat may be sensed using IR optical sensors, electrical resistance thermometers, mechanical thermometers, etc. The combination of which, may produce a “thermal sensor profile.” However, the term, “sensor profile” may be used interchangeably with other terms such as “sensor information,” “sensor data,” “sensor signal,” etc.

PMD 100 may include a handle 120 for the user to hold. Handle 120 can house one or more buttons 190, or other similar control elements, which allow the user to adjust various characteristics of the output of the personal massaging device 100, such as vibration intensity, temperature, or which on-board algorithm is in control of the input-output relationship, etc. The locations of the various components, the handle 120 and main body 110 are depicted in FIG. 1 as merely one example, and various configurations, as well as combinations of hardware, may be employed.

PMD 100 can further include one or more memory unit(s) 170 capable of storing, encoding or carrying a set of instructions for execution by the processor unit 180 of PMD 100 and that may cause the PMD 100 to perform any one or more of the methodologies of the presently disclosed technique and innovation. According to some embodiments, a memory unit 170 may store a configuration template used by the processor 180 to interpret filter/transform and/or interpret sensors profiles received from sensors 102/140 and generate an output. Examples of memory unit(s) include, but are not limited to, recordable type media such as volatile and non-volatile memory devices, removable and non-removable flash memory drives, hard disk drives, and any combination thereof.

PMD 100 may also include an interface 195 configured to transmit to and receive data from other device via wired and/or wireless connections. Interface 195 may be configured to mediate data receipt and transmission over a network and/or dedicated point-to-point connection using any known and/or convenient communications protocol supported by the PMD 100 and the remote device. For example, interface 195 may include combinations of hardware and software enabling communication with other devices via wired connections, and wireless connections (e.g., Wi-Fi or Bluetooth™)

PMD 100 may also include a processor unit 180. Processor unit 180 may be a programmable processor configured to control the operation of the personal massaging device 100 and its components based on instructions stored in memory unit 170. For example, the processor unit 180 may be a microcontroller (“MCU”), a general purpose hardware processor (e.g., a CPU), a graphics processing unit (GPU), a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

It shall be appreciated that PMD 100 as shown in FIG. 1 represents an example PMD according to some embodiments. A person having ordinary skill in the art will recognize in view of the disclosure herein that the components shown in FIG. 1 may be part of a single device or may be distributed among several functionally coupled devices. For example, sensor units 102 may be incorporated into another wearable item such as a watch, a ring, earrings, spectacles, clothing etc., and be positioned on the body of a person in such a way to enable reception of the related sensor data. As a non-limiting illustrative example, a smart watch device may include electric potential and optical sensors on the wristband of the watch, which through contact with the skin of a user, may be capable of sensing both the heart rate and blood oxygen levels of the user. Data picked up by these sensors (in either raw or processed form) may then be transmitted to a PMD 100 wirelessly (e.g., via Wi-Fi or Bluetooth™).

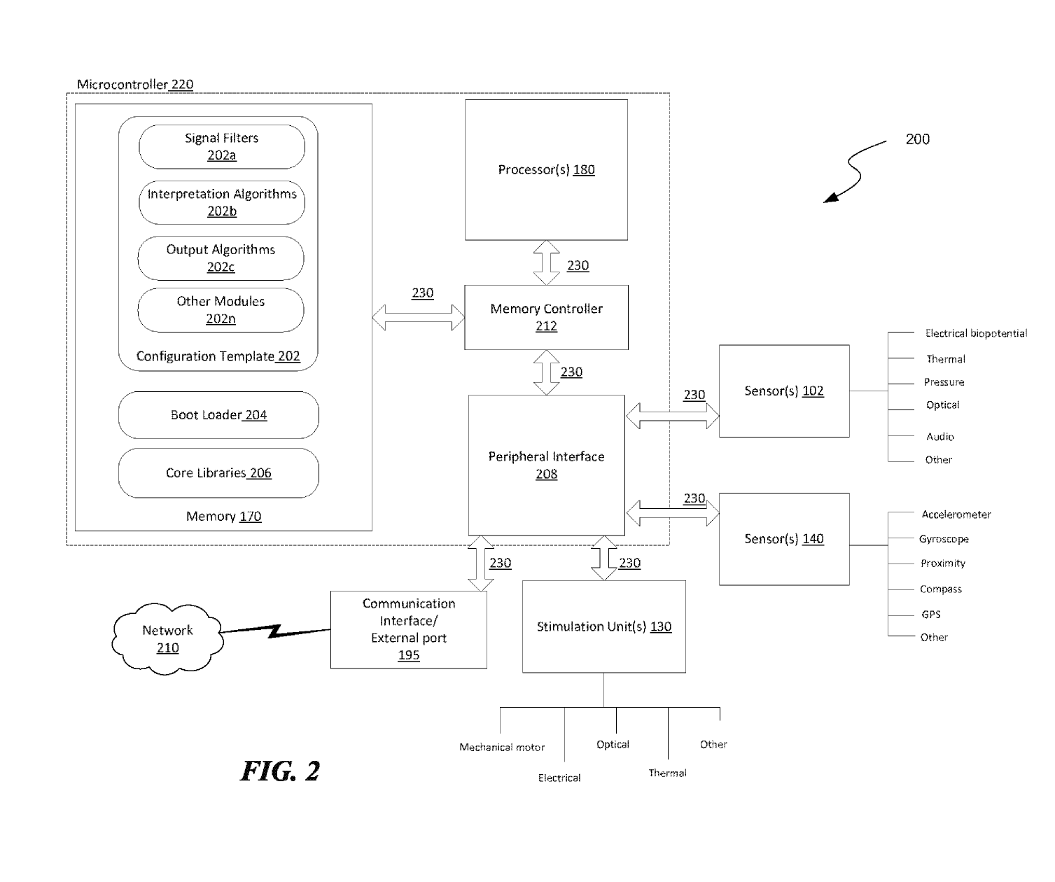

FIG. 2 shows a block diagram of an example system architecture 200 for a PMD, according to some embodiments. It shall be appreciated that architecture 200 presents a high-level diagram of an architecture for one example of a PMD, and that a PMD as implemented may have more or fewer components than shown, may combine two or more components, or a may have a different configuration or arrangement of the components. The various components shown in FIG. 2 may be implemented in hardware, software or a combination of both hardware and software, including one or more signal processing and/or application specific integrated circuits.

As shown in FIG. 2, and as previously discussed with reference to FIG. 1, a PMD may include sensor(s) 102 and 140, processor(s) 180, a memory 170, stimulation unit(s) 130, and a communication interface/external port 195. Further, components such as sensor(s) 102 and 140, stimulation units 130 and communications interface/external port 195 may transmit data via one or more buses 230 via a peripheral interface 208.

As previously mentioned, memory 170 may include high-speed random access memory and may also include non-volatile memory, such as one or more magnetic disk storage devices, flash memory devices, or other non-volatile solid-state memory devices. Further, access to memory by other components of a PMD 100, such as the processor(s) 180 and the peripheral interface 208, may be controlled by the memory controller 212.

The peripheral interface 208 couples the input and output peripherals of the PMD system to the processor(s) 180 and memory 170. One or more processor(s) 180 may run or execute various software programs and/or sets of instructions stored in memory 170 to perform various functions for the PMD and to process data.

In some embodiments, the peripheral interface 208, the processor(s) 180, and the memory controller 212 may be implemented on a single chip, such as an integrated circuit chip. In some other embodiments, they may be implemented on separate chips.

In some embodiments the peripheral interface 208, the processor(s) 180, the memory 170, and the memory controller 212 may be implemented on a single processing board, such as a microcontroller 220. For example, microcontroller 220 may include an-over-the-counter integrated microcontroller, such as an Arduino®-based board.

The communications interface 195 may facilitate transmission and reception of communications signals often in the form of electromagnetic signals. The transmission and reception of electromagnetic communications signals may be carried out over physical media such copper wire cabling or fiber optic cabling, or may be carried out wirelessly for example, via a radiofrequency (RF) transceiver. In some embodiments the network communications interface may include RF circuitry. In such embodiments RF circuitry may convert electrical signals to/from electromagnetic signals and communicate with communications networks and other communications devices via the electromagnetic signals. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth™, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, or any other suitable communication protocol, including communication protocols not yet developed as of the filing date of this document.

The PMD may also include a power system for powering the various components. The power system may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

According to some embodiments, the software components stored in memory may include an operating system and various software modules and applications. An operating system (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

According to some embodiments, memory 170 may include a non-volatile component, for example a flash storage component in which various software modules may be stored. For example, software modules may include core libraries 206, a boot loader 204, and the configuration template 202. Memory 170 may also include a volatile component such as Static Random Access Memory (SRAM) in which the software modules and programs discussed previously may create and manipulate temporary data while running Memory 170 may also include a secondary non-volatile portion (e.g., an EEPROM) intended for storing small amounts of data between resets. For example, an EEPOM may be implemented to store credentials (e.g., an application programming interface (API) or authentication key or some other unique identifier) that may allow newly downloaded configuration templates to interact with the other components of the PMD system (e.g., core libraries 206). Such credentials may be used to restrict the types of configuration templates 202 that may be downloaded and interact with other device components. Third-party developers with access to an API key through a software development kit (SDK) may develop configuration templates 202 capable of running on a PMD 100.

Configuration template 202 may include data that defines how sensor signals gathered by sensors 102/140 are filtered and interpreted, and how outputs (e.g., stimulation outputs) are generated. As shown in FIG. 2, a configuration template 202 may include modules 202a-c for defining such functionality as well as other modules 202n. It shall be understood that although these components are shown in FIG. 2 as discrete modules, this is done for illustrative purposes only, and is not to be construed as limiting. Configuration template 202 may be one or more portions of code in a larger software module, may be a stand-alone module, may include one or more additional modules (as shown), or any combination thereof.

A boot loader 204 may be a program stored in memory 170 that may perform the initial loading of an operating system (if present) and the configuration template 202 in PMD 100. According to some embodiments, a configuration template 202 may access functionality defined in core libraries 206 stored in memory 170. For example, core libraries 206 may define system functions, including but not limited to, power management, sensor management and calibration, network communications, data structures and processes, mathematical functions, memory management, output device control and calibration, etc. According to some embodiments, each PMD 100 may be pre-loaded with the same core libraries 206. A loaded configuration template 202 may therefore include instructions for providing performing the methods described herein, while making use of one or more functionalities of the core libraries 206. However a person having ordinary skill in the art will recognize in view of the disclosure herein that core libraries 206 may be part of the configuration template 202, according to some embodiments.

The signal filters module 202a may include software implemented digital signal filter algorithms that transform raw and/or processed sensor data gathered from sensors into new data that may be more useful to the system. As a non-limiting example used for illustrative purposes, a configuration template 202 may include algorithms used to more accurately define position, motion and, orientation based on raw data from sensors 140 (e.g., an accelerometer). A nonlinear estimation algorithm (one example being an extended Kalman filter) may be defined to take state data in the form of a series of measured positions and/or orientations and in near real time predict a current position and/or orientation based on assumed uncertainties in the observed data. In this example, this may define how a PMD 100 registers motion. For example, relatively small, erratic changes in position may not register as an intended motion or gesture, while relatively large changes in position and/or orientation may register as an intended motion or gesture. A person having ordinary skill in the art in view of the disclosure herein will recognize that raw sensor data of any type (e.g., electrical biopotential, thermal, optical, pressure, audio, etc.) may also be processed using other algorithms known in the art.

Configuration template 202 may also include software implemented interpretation algorithms 202b for interpreting or otherwise analyzing gathered raw and/or processed sensor profiles, for example, in the context of human sexual response. According to some embodiments, sensor profiles gathered from sensors 102/140 may be combined and/or correlated in order to infer a physiological response of a person to stimulation provided via a PMD 100. For example, the degree of correlation between sensed muscle contractions (e.g., using biopotential or pressure sensors 102) and device activity (e.g., sensed using accelerometer 140 and/or data from stimulation units 130) may be indicative of a sexual response to stimulation.

Individual variables may be scaled or transformed, using various psychometric response curves, into regions which are more informative of state. For example, a square root function may be applied to pressure data contained in a pressure sensor profile, to highlight variation in pressure over time when the overall applied pressure at any given moment is relatively small, while keeping the value within a reasonable range when the pressure becomes relative large.

Collections of variables may be transformed into other variables. For example, some transformations can be calculated analytically, such as using the acceleration data from sensor 140 to calculate orientation and/or velocity along an axis. Alternatively, the data from multiple discrete pressure sensors may be transformed to provide data about where along PMD 100 the pressure is being applied.

Common mathematical operations, as well as common filtering operations (as described earlier), may be applied to individual variables. These may include derivative/integral, filtering (high-pass, lowpass, bandpass, with a selectable number of poles, frequencies, etc.), or thesholding or other non-linear techniques In addition, running statistics, such as the standard deviation of sensed pressure over the last several seconds, may be applied.

Correlations among and between variables may also be used to create additional variables. These correlations may be in the form or standard linear correlations (such as Pearson's R), cross correlations, or correlations between other derived variables (for instance, pressure time derivative and the velocity). These correlations can be taken over some time window, typically on the order of several seconds or longer. According to some embodiments, the size of the time window itself can be adjusted dynamically. The newly derived variables may be used in a number of different ways.

According to some embodiments, interpretation algorithms 202b may process sensor profile data relative to models of human sexual response in order to determine if the gathered data is indicative of sexual response by the person using the PMD 100. A model of human sexual response may be based on historical observations that relate patterns of physiological response to sexual stimulation. As a simplified example, general human sexual response is understood by some to comprise at least four stages or phases forming a cycle: excitement, plateau, orgasm, and resolution. This cycle of human sexual response was first proposed by William H. Masters and Virginia E. Johnson in their book “Human Sexual Response” (Bantam, 1981; 1st ed. 1966). According to this model, the excitement phase may be characterized by an increase in heart rate, blood pressure, and temperature at the skin due to flushing. An increase in muscle activity and tone (described generally as myotonia) occurring both voluntarily and involuntarily may begin during this phase. The excitement phase is further characterized by swelling (through vasocongestion) of tissue in and around the reproductive organs. The plateau phase represents the phase prior to climax or orgasm and may be characterized by even further increases in muscle tension, heart rate, and blood pressure. Orgasm occurs at the conclusion of the plateau phase and may be characterized by even further increases in heart rate and blood pressure as well as sudden involuntary muscle contractions in and around the reproductive organs as well as vocalizations in some instances and muscle spasms in other parts of the body. The resolution phase follows orgasm and is characterized by a slow down or lessening of the above described physiological responses as the body returns to a pre excitement state. A person having ordinary skill in this area will recognize that the above provides an over simplified description of human sexual response. Specifics of response may vary widely from person to person. However, the above provides a conceptualization of what may comprise a model of human sexual response. According to some embodiments, a model of human sexual response may be static and pre-defined, based on historical data gathered during previous scientific testing. According to some embodiments, a model of human sexual response may be dynamically constructed using machine learning algorithms as new data is gathered. An example machine learning algorithm implementing a closed feedback loop is discussed in more detail herein with respect to adjustments to the interpretation algorithms 202b and output algorithms 202c of configuration template 202, however a person having ordinary skill will recognize that such methods may be applied to adjusting the underlying model of human sexual response as well.

In a first non-limiting example, a configuration template 202 may be coded such that intentional motions of a PMD 100 along a single axis (e.g., back and forth) may be interpreted as a specific gesture by a person using the PMD 100 which may increase the intensity of output by stimulation units 130. In a second non-limiting example, a configuration template 202 may be coded to interpret patterns in a pressure sensor profile gathered by pressure sensors 102 as corresponding to muscle contractions indicative of a sexual response to stimulation (e.g., excitement or orgasm). In a third non-limiting example, a configuration template 202 may be coded to interpret certain characteristic patterns in received sensor profiles that may indicate changes in user attention and/or alertness correlated in time with a stimulus. For example, a decrease in heart rate and blood pressure may be indicative of either the resolution phase following orgasm or a decrease in excitement prior to reaching orgasm. An interpretation of the sensor profile data may therefore depend previously received sensor profile data. In other words, if an orgasm is detected, a following decrease in heart rate and blood pressure may be interpreted by the interpretation algorithms as a resolution phase following the orgasm.

Further, although generalized patterns may be recognizable, it is understood that each person may exhibit unique characteristics in both response to stimulation and experience based on the response. In other words, while an orgasm may be characterized by a certain sensor profile pattern in one person, an orgasm in another may be characterized by a different sensor profile pattern. Therefore, a configuration template 202 may be customized to the specifics of a person using the PMD 100 or another person all together. For example, a configuration template 202 may be customized and tweaked to more effectively interpret the sensor profiles indicating a sexual response by a person using a PMD 100. The methods by which a configuration template 202 may be adjusted are discussed in more detail in later paragraphs.

A configuration template 202 may also include software implemented output algorithms 202c for generating outputs based on the interpreted sensor profiles. According to some embodiments, generated outputs may be control signals to stimulation units 130 associated with PMD 100. Consider an example scenario in which a person using a PMD 100 exhibits waning levels of excitement as indicated based on the application of interpretation algorithms 202b to received sensor profiles. Based on this interpretation, output algorithms 202c may adjust control signals to stimulation units 130 (e.g., vibrating motors) to increase excitement levels. Here, the output algorithms 202c may be configured to increase vibration intensity to increase excitement levels. Alternatively, the output algorithms 202c may be configured to introduce a particular pulse pattern to increase excitement levels. It will be appreciated that, as with the interpretation algorithms 202b, output algorithms 202c may need to be configured to meet the particular needs of the person using the PMD 100. Where one person may respond favorable to an output stimulus, another may not. As with respect to the interpretation algorithms 202b, the configuration template 202 may be customized and tweaked to generate different outputs based on the received and interpreted sensor profiles.

Customization of the configuration template 202 may be performed manually by rewriting the underlying code or adjusting variable parameters associated with the underlying code. According to some embodiments, a configuration template 202 may be customized by adjusting variable parameters via a graphical interface. For example, a graphical interface may be presented via a display of a computing device (e.g., a laptop or tablet device) through which a user (either a person using the PMD 100 or template developer) may adjust the variable parameters of a configuration device 202. A user may adjust parameters of the configuration template via an input device associated with the computing device, for example a keyboard of a laptop or the touch screen interface of a tablet device. The graphical interface may be presented via software instantiated locally on the computer device on one or more remote servers, for example, accessible via a web browser interface. Once a user has input their adjustments to the configuration template 202 an updated configuration template may be rendered and transmitted to PMD 100 for use (e.g., via communications interface 195).

According to some embodiments, a configuration template 202 may be automatically and dynamically adjusted over time, using one or more machine learning algorithms (generally, artificial intelligence or AI), in response to the received plurality of sensor profiles. A machine learning or “self-learning” algorithm may adjust aspects of the one or more components of the configuration template (e.g., signal filters 202a, interpretation algorithms 202b, and output algorithms 202c) in response to feedback in the form of received sensor profiles from sensors 102/140. Accordingly, such algorithms may employ a closed feedback loop that may continuously set parameters affecting outputs in the form of stimuli, receive feedback inputs in the form of received sensor profiles, adjust the parameters in response to a comparison of the received input against a reference input, and repeat. A reference input may be based on an expected or desired biofeedback response by a person using the PMD 100. As a simplified example for illustrative purposes, the general “goal” of a PMD 100, according to some embodiments, may be to assist a person using the device in achieving an orgasm. Under that assumption, the PMD 100 through stimulation units 130 may produce a stimulation output X intended to induce a sexual response by a person. In response, PMD 100, via sensors 102/140, may receive sensor profiles which may be interpreted by interpretation algorithms 202b as indicative of a particular physiological response by the person. Here the reference input A may be the intended response with the actual input B the received biofeedback sensor profiles. A comparator (part of the machine learning algorithm) may compare the reference input A to the actual input B. Based on the comparison, the output X may be adjusted according to a gradient with certain constraints. For example, output X may be incremented in one area (e.g., vibration) according to the gradient (but within preset constants) by adjusting the output algorithms 202c. The resulting adjusted output X₁ may then cause a different biofeedback response B₁ by the person, which may then be fed back into the feedback loop of the machine-learning algorithm.

According to some embodiments reference inputs and constraints may be adjusted based input by the person using the PMD 100. The perceived pleasure experienced by a person using a PMD 100 may be highly subjective and differ from person to person. Accordingly, the person using the PMD 100 may provide inputs that may guide the machine learning algorithms. For example, PMD 100 may include a simple interface device such as “like” and “dislike” button, which person using the PMD 100 may press to inform the machine learning algorithms whether a particular output was pleasurable or not. Based on such inputs, the machine learning algorithm may adjust the reference input to more closely match what the person has indicated is pleasurable or adjust constraints to avoid outputs that the person has indicated are not pleasurable.

The configuration templates 202 may be adjusted for a number of reasons. As previously mentioned, the configuration templates 202 may be adjusted to meet the particular needs of the person using the PMD 100. The output algorithms may also be adjusted to provide a particular experience or fantasy. For example, another person (e.g., celebrity of some type) may offer configuration templates 202 based on their own preferences for download by others. According to some embodiments, these available configuration templates may be offered for a fee. The idea of an online market place for configuration templates is discussed in more detail herein. According to some embodiments this available configuration template may be based on the other person's use of a PMD 100 or similar device. According to some embodiments this available configuration template may be based on manually adjusted parameters (e.g., via re-coding or a graphical interface as discussed earlier).

A configuration template 202 may also include a choreographed sexual experience. For example, a configuration template may include instructions to follow a preset progression of outputs that may provide a particular experience to the person using the PMD 100. As explained earlier, stimulation units 130 may produce a number of different stimuli, including but not limited to, vibration, motion, electrical, optical, and thermal. As a non-limiting example for illustrative purposes, a choreographed sexual experience may provide progression of outputs starting with vibration and motion, applying heat, increasing intensity of vibration, and then following with electrical stimulation. It shall be appreciated that the choreographed sexual experience need not be identical each time. Similar to a video game which may follow a script but nevertheless respond to user inputs, a choreographed sexual experience may follow a choreographed script but adjust outputs based on received inputs (e.g., via sensors 103/140) or direct inputs from a person via an input device.

### System for Configuring a Smart Personal Massaging Device

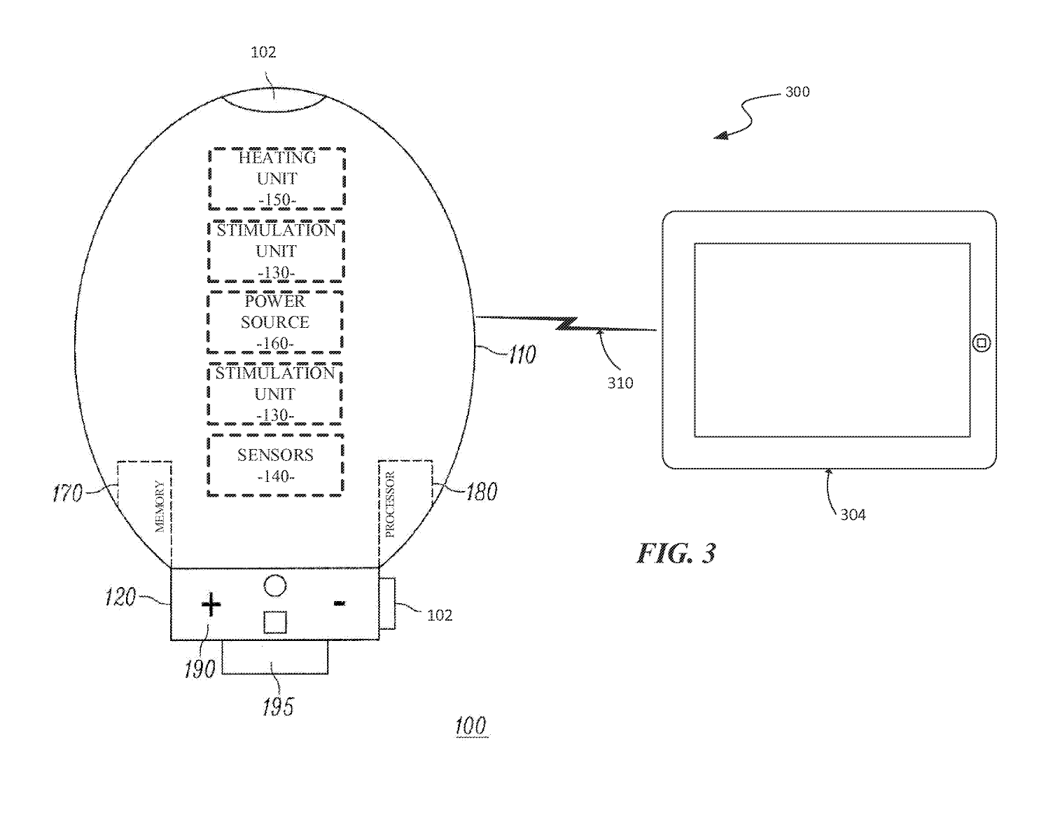

FIG. 3 shows a conceptual diagram of an example system 300 for configuring a PMD 100, according to some embodiments.

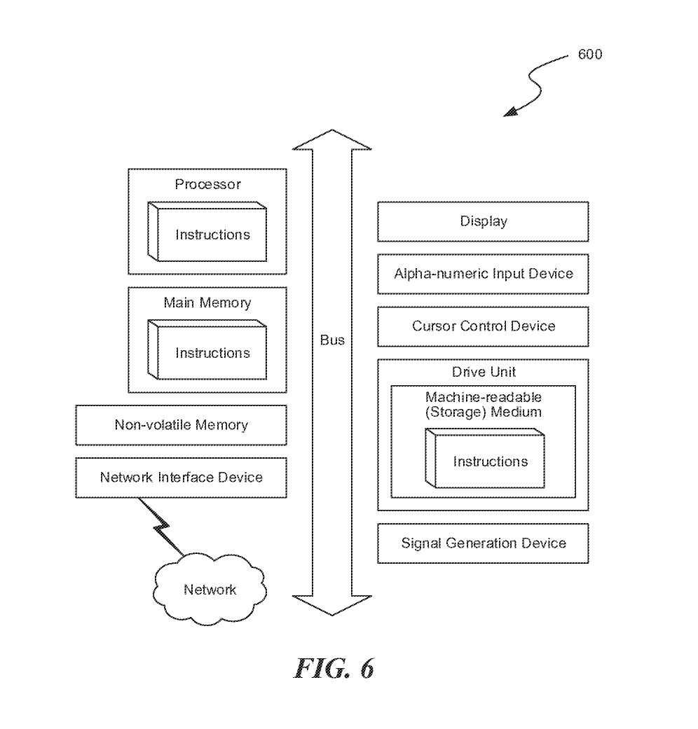

According to some embodiments, system 300 may include a PMD 100 interfaced with one or more general computing devices 304 via a connection 310. Computing device 304 is illustrated in FIG. 3 as a tablet device (e.g., an iPad®), however computing device 304 may be any combination of hardware and/or software capable of storing a set of instructions and executing processes based on those instructions (as illustrated in FIG. 6 and described in more detail under the section titled “Computing Systems/Devices). For example, the computing device 304 may include any following non-limiting list of example devices: a server, a desktop computer, a computer cluster, a notebook computer, a laptop computer, a handheld computer, a palmtop computer, a mobile phone, a cell phone, a personal digital assistant (PDA), a smart phone (e.g., Apple® iPhone®, etc.), a tablet (e.g., Apple® iPad®, etc.), a phablet (e.g., HTC Droid DNA™, etc.), a tablet PC, a thin-client, a game console (e.g., Microsoft® XBOX®, etc.), a hand held gaming device (e.g., Sony® Vita™), mobile-enabled powered watch (e.g., Apple® Watch™, etc.), a smart glass device (e.g., Google® Glass™, etc.) and/or any other portable, mobile, hand held devices, etc. running on any platform or any operating system (e.g., OS X™, iOS™, Windows™ Mobile, Android™, Blackberry™ OS, Embedded Linux™ platforms, Palm™ OS, Symbian™ platform, Google® Chrome™ OS, etc.).

Computing device 304 may further include input mechanisms (e.g., a touch pad, physical keypad, a mouse, a pointer, a track pad, motion detector, etc.), display devices (e.g., CRT/LCD screen, projector, smart glass display, etc.) and one or more sensors (e.g., an optical sensor, capacitance sensor, resistance sensor, temperature sensor, proximity sensor, a piezoelectric device, device orientation detector (e.g., electronic compass, tilt sensor, rotation sensor, gyroscope, accelerometer), etc.), or a combination thereof.

PMD 100 may connect with one or more computing device(s) 304 via connection 310. In general connection 310 may include any mode of wired or wireless communication over dedicated connection or one or more open or private networks. According to some embodiments, connection between PMD 100 and computing device 304 may achieved via a dedicated radio-frequency based wireless connection (e.g., using the Bluetooth™ standard), via a dedicated wired I/O connection (e.g., Universal Serial Bus (USB), Firewire™, Thunderbolt™, etc.), via an open wireless network (e.g., a Wi-Fi based local area network connected to the Internet), via an open wired network (e.g., through an Ethernet-based local area network (e.g., using twisted pair cabling links) connected to the Internet), via a closed wireless network (e.g., a Wi-Fi based local area network intranet), or any combination thereof.

According to some embodiments, a configuration template 202 may be created on a computing device 304. As mentioned earlier, a configuration template 202 may be created by writing the underlying code in the software or customizing a preset configuration template 202. According to some embodiments, a preset configuration template 202 may be customized by adjusting variable parameters via a graphical interface. For example, a graphical interface may be presented via a display of a computing device 304 (e.g., a laptop or tablet device) through which a user (either a person using the PMD 100 or template developer) may adjust the variable parameters of a configuration template 202. A user may adjust parameters of the configuration template 202 via an input device associated with the computing device, for example a keyboard of a laptop or the touch screen interface of a tablet device. The graphical interface may be presented via software instantiated locally on the computing device 304 on one or more remote servers, for example, accessible via a web browser interface.

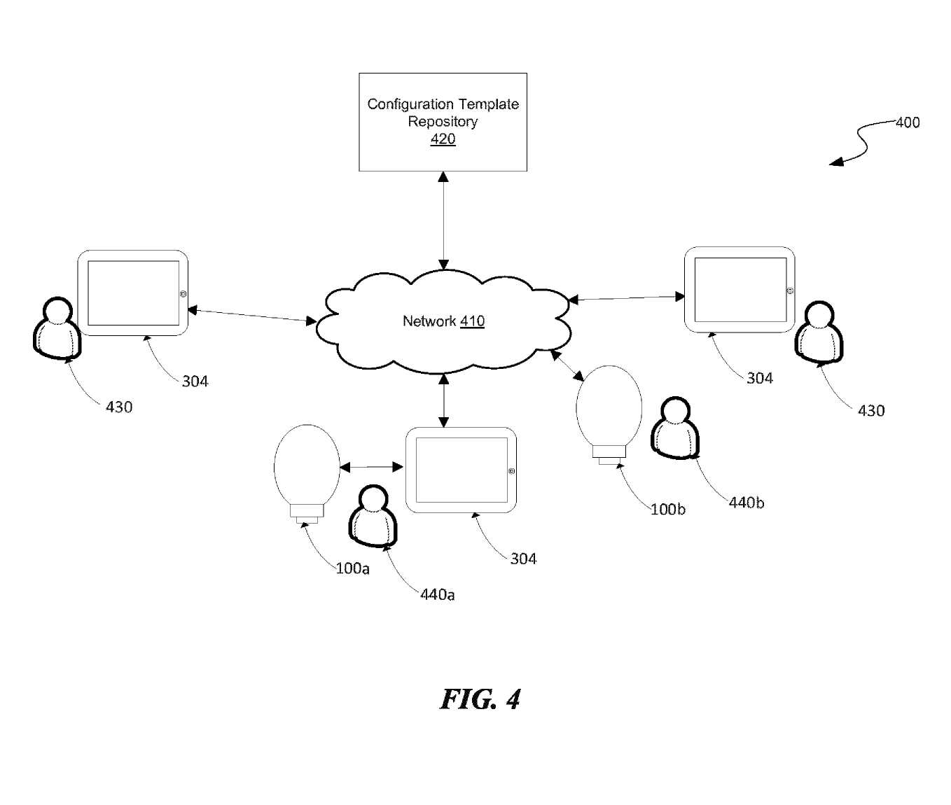

According to some embodiments, a configuration template 202 may be received via download either directly to a PMD 100 or via computing device 304. A system for downloading configuration templates from a network is described in more detail with reference to FIG. 4.

Returning to FIG. 3, once a user has downloaded, created, or customized a configuration template 202, the configuration template 202 may transmitted to PMD 100 for use (e.g., via connection 310 and communications interface 195).

FIG. 4 shows a diagram of an example system 400 for accessing remotely available configuration templates 202 according to some embodiments. According to some embodiments, system 400 may include a plurality of PMDs 100 and computing devices 304 connected to one or more remote configuration template repositories 420 via one or more networks 410.

All of the aforementioned computing devices, including PMDs 100, computing devices 304 and any computing devices associated with configuration template repository 420, may be connected to each other through one or more wired and/or wireless networks, for example network 410. In general, network 410 may be a cellular network, a telephonic network, an open network, such as the Internet, or a private network, such as an intranet and/or the extranet, or any combination or variation thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 410 can be any collection of distinct networks operating wholly or partially in conjunction to provide connectivity the computing devices shown in FIG. 4 and may appear as one or more networks to the serviced systems and devices. In one embodiment, communications to and from the devices may be achieved by, an open network, such as the Internet, or a private network, such as an intranet and/or the extranet. In one embodiment, communications can be achieved by a secure communications protocol, such as secure sockets layer (SSL), or transport layer security (TLS). Example networks that may comprise network 410, include, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth™, WiFi, Fixed Wireless Data, 2G, 2.5G, 3G (e.g., WCDMA/UMTS based 3G networks), 4G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1×RTT, and EV-DO, or any other communications networks. Further, the aforementioned networks may implement various transmission protocols, including but not limited to, one or more of, TCP/IP, UDP, SMS, MMS, extensible messaging and presence protocol (XMPP), real time messaging protocol (RTMP), instant messaging and presence protocol (IMPP), instant messaging, USSD, IRC, or any other protocols suitable for transmission of data.

FIG. 4 shows a high-level diagram of a configuration template repository 420, and it shall be understood that repository 420 may be composed of any combination of computing hardware and software, for example including hardware components as described with reference to FIG. 6. Further, it shall be understood that repository 420 may include components (e.g., server computers) hosted at a single physical location or may include components distributed at multiple physical locations in communication with each other via, for example, network 410. It shall also be understood that system 400 may include fewer or more components than as shown in FIG. 4. Users 430 and 440 may access remotely stored configuration templates stored at repository 420 via network 410 a number of ways, including, but not limited to via client software instantiated on computing devices 304, or via a web browser instantiated on computing devices 304.

According to some embodiments, access to configuration templates may be provided via repository 420 and may include an online store or file exchange. Users 430 may develop or customize configuration templates via computer devices 304 and may upload the configuration templates to repository 420 where they may be made available for download via an online store or file sharing service. Configuration templates may be made available for free, on a pay-per-download basis, or as part of a subscription service. A user 440a (person using a PMD 100) may download configuration templates from the online store or file sharing service to a computer device 304 which may then transfer the template to a PMD 100, for example, via a wireless connection such as Wi-Fi, or Bluetooth™. Alternatively, a user 440b (person using a PMD 100) may download a configuration template from the online store or file sharing service directly to the PMD 100.

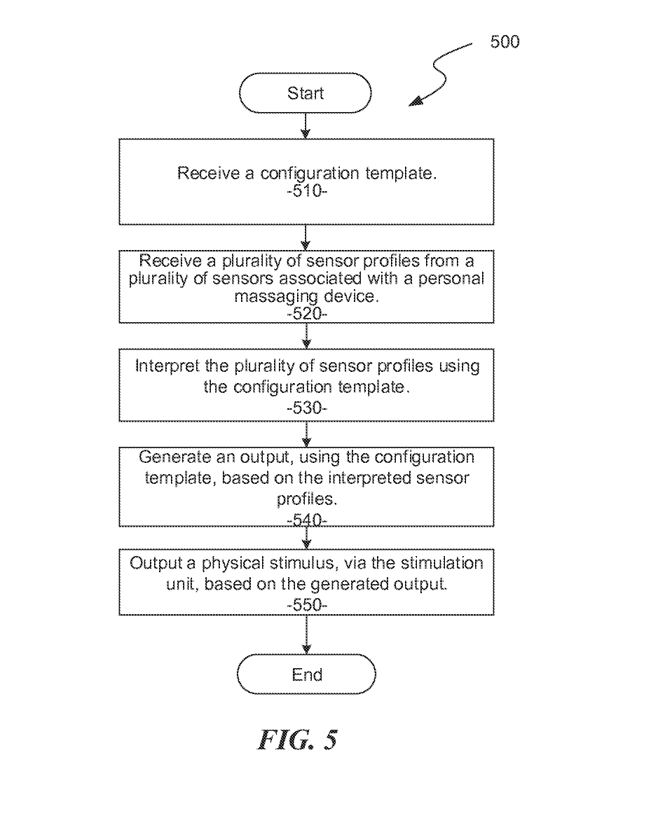

FIG. 5 shows a flow chart of an example method 500 for configuring a PMD 100, according to some embodiments. At step 510, a configurable PMD 100 may receive a configuration template 202. Details of the configuration template 202 are discussed in further detail in earlier paragraphs with reference to FIG. 2. According to some embodiments, the configuration template 202 may be received via a download from a network 410 (e.g., the Internet) as discussed with reference to FIG. 4. According to some embodiments, a configuration template 202 may be received directly from a computing device 304 over a connection 310 as discussed with reference to FIG. 3. At step 520, a configurable PMD 100 may receive a plurality of sensor profiles from a plurality of sensors 102/140 associated with PMD 100 as discussed with reference to FIGS. 1-2.

At step 530, processor(s) 180 associated with a PMD 100 may interpret the plurality of sensor profiles using a configuration template 202 stored in memory 170. According to some embodiments, processor(s) 180 may interpret the plurality of sensor profiles using interpretation algorithms 202b of a configuration template 202, wherein the interpretation algorithms 202b are configured and/or designed to interpret sexual response by the person using the PMD 100 based on the received sensor profiles.

At step 540, processor(s) 180 associated with a PMD 100 may generate an output using a configuration template 202 stored in memory 170. According to some embodiments, processor(s) 180 may generate an output using an output algorithm 202c of a configuration template 202, wherein the output algorithm 202c is configured and/or designed to induce a sexual response by the person using the PMD 100. According to some embodiments, the generated outputs may be control signals configured to control one or more output device such as the stimulation units 130 of the PMD 100. At step 550, a stimulation unit 130 associated with PMD 100 may output a physical stimulus. The physical stimulus may be based on the output control signals generated at step 540. The types of output physical stimulation are discussed in more detail above with reference to FIG. 1.

### Computing Systems/Devices

FIG. 6 shows a diagrammatic representation of a machine 600 in the example form of a computer system within which a set of instructions, for causing the machine to perform any one or more of the methodologies discussed herein, can be executed.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine may be a server computer, a client computer, a personal computer (PC), a user device, a tablet, a phablet, a laptop computer, a set-top box (STB), a personal digital assistant (PDA), a thin-client device, a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed repository, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 600 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

The various example embodiments disclosed herein include the following example embodiments:

A computer-implemented method of configuring a sexual stimulation device, the method comprising: receiving a configuration template; receiving a plurality of sensor profiles from a plurality of sensors; wherein, one or more of the plurality of sensor profiles are associated with a biofeedback response by a person using the sexual stimulation device; wherein, one or more of the plurality of sensor profiles are associated with a position, orientation, or motion of the sexual stimulation device; interpreting the plurality of sensor profiles using the configuration template; and generating an output, using the configuration template, based on the interpreted plurality of sensor profiles.

The method as claimed above, further comprising: outputting a physical stimulus, via the sexual stimulation device, based on the generated output.

The method as claimed above, wherein the interpreting comprises: interpreting a sexual response by the person using the sexual stimulation device; wherein, the interpreting is based on an interpretation algorithm of the configuration template.

The method as claimed above, wherein the generating an output comprises: generating an output designed to induce a sexual response by the person using the sexual stimulation device; wherein, the generating is based on an output algorithm of the configuration template.

The method as claimed above, further comprising: dynamically adjusting the configuration template over time, using a machine learning algorithm, in response to the received plurality of sensor profiles.

The method as claimed above, wherein the configuration template includes an application programming interface (API).

The method as claimed above, wherein the configuration template is based on characteristics of sexual response of another person.

The method as claimed above, wherein the configuration template includes a choreographed sexual experience.

The method as claimed above, wherein the receiving the configuration templates comprises: downloading the configuration templates wirelessly via the Internet.

A configurable sexual stimulation system, comprising: means for outputting a physical stimulus; means for, receiving a configuration template; means for, receiving a plurality of sensor profiles; wherein, one or more of the plurality of sensor profiles are associated with a biofeedback response by a person to the physical stimulus; wherein, one or more of the plurality of sensor profiles are associated with a position, orientation, or motion of the means for outputting the physical stimulus; means for, interpreting the plurality of sensor profiles using the configuration template; and means for, generating an output, using the configuration template, based on the interpreted plurality of sensor profiles; and means for, outputting an adjusted physical stimulus based on the generated output.

The description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A configurable sexual stimulation system, comprising:
a processor unit;
a stimulation unit configured to output a physical stimulus;
an interface unit configured to receive data;
a plurality of sensors configured to sense a plurality of sensor profiles;
wherein, one or more of the plurality of sensor profiles are associated with a biofeedback response by a person using the stimulation device;
wherein, one or more of the plurality of sensor profiles are associated with a position, orientation, or motion of the stimulation device; and
a memory unit having instructions stored thereon, which when executed, cause the processor to:
receive a configuration template via the interface unit;
receive the plurality of sensor profiles, via the interface unit, from the plurality of sensors;
interpret the plurality of sensor profiles using the configuration template;
generate an output, using the configuration template, based on the interpreted plurality of sensor profiles; and
output a physical stimulus, via the stimulation unit, based on the generated output.

2. The configurable sexual stimulation system of claim 1, wherein the configuration template includes an interpretation algorithm for interpreting a sexual response by the person based on the received sensor profiles.

3. The configurable sexual stimulation system of claim 1, wherein the configuration template includes an output algorithm for generating an output designed to induce a sexual response by the person.

4. The configurable sexual stimulation system of claim 1, wherein the memory has instructions, which when executed, cause the processor to further: dynamically adjust the configuration template over time, using a machine learning algorithm, in response to the received plurality of sensor profiles.

5. The configurable sexual stimulation system of claim 1, wherein the configuration template includes an application programming interface (API).

6. The configurable sexual stimulation system of claim 1, wherein the configuration template is modifiable by a user.

7. The configurable sexual stimulation system of claim 6, wherein the configuration template is modifiable by a user via a graphical interface.

8. The configurable sexual stimulation system of claim 1, wherein the configuration template is based on characteristics of sexual response of another person.

9. The configurable sexual stimulation system of claim 1, wherein the configuration template includes a choreographed sexual experience.

10. The configurable sexual stimulation system of claim 1, wherein the plurality of sensors include one or more of the following: electrical potential sensors, optical sensors, pressure sensors, and thermal sensors.

11. The configurable sexual stimulation system of claim 1, wherein the plurality of sensors include one or more of the following: accelerometers, global positioning system (GPS) receivers, and proximity sensors.

12. The configurable sexual stimulation system of claim 1, wherein the physical stimulus include one or more of the following: vibration, heat, illumination, and electrical muscle stimulation (EMS).

13. The configurable sexual stimulation system of claim 1, wherein the interface unit is configured to receive data wirelessly via a network.

14. The configurable sexual stimulation system of claim 1, wherein at least one of the plurality of sensor profiles include an electrocardiogram (EKG) signal.

15. The configurable sexual stimulation system of claim 1, wherein at least one of the plurality of sensor profiles include data related to the one or more of the following: galvanic skin response, heart rate, oxygen level, applied pressure, temperature, and respiration.

16. The configurable sexual stimulation system of claim 1, wherein interpretation of the plurality of sensor profiles is based on a rate of change of one or more of the plurality of sensor profiles.

17. The configurable sexual stimulation system of claim 1, wherein interpretation of the plurality of sensor profiles is based on a correlation between two or more of the plurality of sensor profiles.

18. A computer-implemented method of configuring a sexual stimulation device, the method comprising:
receiving a configuration template;
receiving a plurality of sensor profiles from a plurality of sensors;
wherein, one or more of the plurality of sensor profiles are associated with a biofeedback response by a person using the sexual stimulation device;
wherein, one or more of the plurality of sensor profiles are associated with a position, orientation, or motion of the sexual stimulation device;
interpreting the plurality of sensor profiles using the configuration template; and
generating an output, using the configuration template, based on the interpreted plurality of sensor profiles.

19. The method of claim 18, further comprising: outputting a physical stimulus, via the sexual stimulation device, based on the generated output.

20. The method of claim 18, wherein the interpreting comprises: interpreting a sexual response by the person using the sexual stimulation device; wherein, the interpreting is based on an interpretation algorithm of the configuration template.
